(19) United States
(12) Patent Application Publication
(10) Pub. No.: US 2008/0160273 A1
(43) Pub. Date: Jul. 3, 2008

(54) Use of High-Density Paper Carrier Containing Groundwood Pulp as a Carrier Web for Anti-Adhesive Release Lacquer Coatings

(75) Inventors: Andreas Wieck, Halstenbek (DE); Nico Diamantis, Hamburg (DE)

Correspondence Address: NORRIS, MCLAUGHLIN & MARCUS, PA, 875 THIRD AVENUE, 18TH FLOOR, NEW YORK, NY, 10022, US

(73) Assignee: TESA AG, Hamburg (DE)

(21) Appl. No.: 11/910,083

(22) PCT Filed: Mar. 15, 2006
(86) PCT No.: PCT/EP2006/060721

§ 371 Date: Nov. 1, 2007

(30) Foreign Application Priority Data
Apr. 6, 2005 (DE) 10 2005 015 876.5

(51) Int. Cl. B32B 7/02

(52) U.S. Cl. 428/218

(57) ABSTRACT

Use of a paper carrier containing groundwood pulp as a carrier web for release lacquer coatings, the proportion of the groundwood pulp in the composition of the paper carrier being at least 5% by weight, preferably at least 20% by weight, the paper carrier having a density of from 0.9 to 1.3 g/cm³, preferably 1.0 to 1.3 g/cm³, the paper carrier having an upper side and a lower side, it being possible for the paper carrier to be provided on the upper side and/or on the lower side with a coating of polyolefin or of an inorganic substance, and an anti-adhesive layer being applied to one of the two coatings that may be provided.

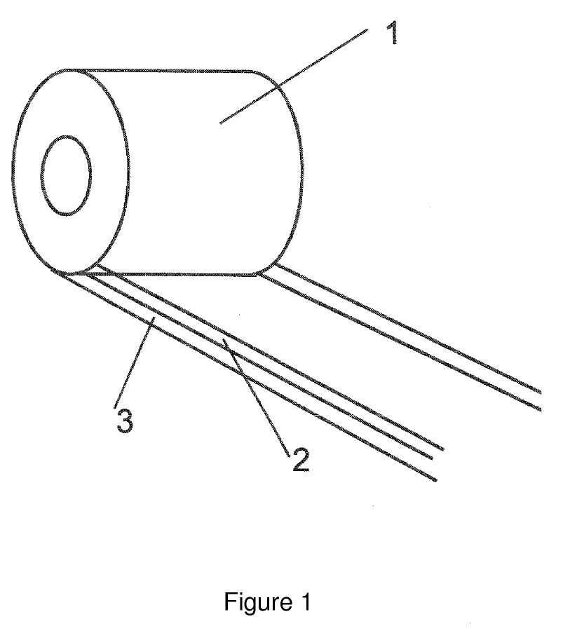

The invention relates to the use of a high-density paper carrier containing groundwood pulp as a carrier web for anti-adhesive release lacquer coatings. Carrier webs of this kind are used as liner material in adhesive tapes.

At the end of the production operation, adhesive tapes coated on one or both sides with adhesives are generally wound up to form a roll. In order to prevent the adhesives coming into contact in the case of double-sided adhesive tapes, or overall in order to prevent sticking of the adhesive to the carrier or to the other adhesive, the adhesive tapes, prior to winding, are applied to a liner material which is wound up together with the adhesive tape. The skilled worker is familiar with such liner materials. The liners are finished in such a way as to be anti-adhesive.

A particularly suitable anti-adhesive material for the liner is an anti-adhesive release paper, based for example on differently highly densified paper bodies (and also release films based on PET, PP, PE).

As a paper carrier web for the release lacquer coating it is common to use highly densified, anti-adhesive, high-grade and chemical-pulp-containing glassine base papers, which are particularly suitable on account of their high densification and surface quality (holdout).

Known from EP 1 272 584 A1 is the use of a paper carrier of this kind, having a density of 1.1 to 1.25 g/cm³, as a carrier web in a liner material for an adhesive tape, the paper carrier having essentially a top face and a bottom face.

The paper carrier is provided on the top and/or bottom face with a polymeric coating, an anti-adhesive layer having been applied at least to one of the two polymeric coatings present where appropriate.

In one advantageous embodiment of the invention the paper carrier is a highly densified glassine paper which has been provided on the top face and on the bottom face with a polymeric coating, an anti-adhesive layer, more particularly a silicone coating, having been applied to both polymeric coatings.

It is an object of the invention to provide a paper carrier which in technical terms is as outstanding as the known carriers but which ought to be at least more favorable in terms of price. The paper carrier ought in particular to be suitable for the coating of highly viscous release lacquers, both alone and in combination with polyolefinic or inorganic coatings (clay).

This object is achieved through the use, as a carrier web for release lacquer coatings, of a paper carrier of the kind specified in the main claim. The dependent claims relate to advantageous developments of the subject matter of the invention.

The invention accordingly provides for the use of a groundwood pulp-containing paper carrier as a carrier web for release lacquer coatings, the fraction of groundwood pulp in the paper composition of the paper carrier being at least 5% by weight, preferably at least 20% by weight, and the paper carrier having a density of 0.9 to 1.3 g/cm³, preferably 1.0 to 1.3 g/cm³.

The paper carrier with a top face and a bottom face may have been provided on the top face and/or on the bottom face with a coating of polyolefin or of an inorganic substance, an anti-adhesive layer having been applied at least to one of the two coatings present where appropriate.

Preferably the paper carrier has a density of 1.12 to 1.2 g/cm³, more particularly 1.14 to 1.16 g/cm³.

With further preference the paper carrier has a basis weight of 40 to 140 g/m², preferably 50 to 110 g/m², very preferably 60 to 100 g/m².

With further preference the paper carrier has an ideal-elastic range of 1.0 to 2.0 kN, preferably 1.2 to 1.8 kN, very preferably 1.4 to 1.6 kN.

In principle, various mixtures of chemical pulp/groundwood pulp are suitable for producing a paper carrier of the invention.

Preferably the fraction of groundwood pulp in the paper composition is 20% to 80% by weight, more preferably 30% to 70% by weight, very preferably 40% to 60% by weight.

As the polymeric coating it is possible in particular to use polyolefins such as LDPE, HDPE or blends of the two aforementioned polyolefins, MDPE, PP or PTE for example.

The poly-coated faces of the paper carrier of LDPE or HDPE can be produced, furthermore, as matt coated faces or as glossy coated faces.

With further preference the polymeric coating is applied at 5 to 30 g/m², preferably 10 to 25 g/m², very preferably 15 to 20 g/m². Particularly in the case of polyester the application may also be just 2 to 3 g/m².

Examples of inorganic coatings which can be used include chalk, kaolin, titanium dioxide or else glue.

Furthermore, one outstanding embodiment of the invention is if, for example, highly viscous silicone-free or low-silicone layers or silicone, paraffin, Teflon, waxes or highly viscous solvent-free systems which function as release lacquers are used as anti-adhesive layers.

Preference is given to using solventlessly coated silicones which by virtue of their coating viscosity are able to compensate unevennesses on the groundwood pulp-containing paper carrier web.

They also have the advantage of not penetrating into the paper carrier, thereby allowing losses to be largely avoided.

Particularly suitable silicones are UV silicones of the kind made available, for example, by the company Goldschmidt (RPS=reduced penetration silicones).

With further preference the solventlessly coated silicone is applied at 0.8 to 3.7 g/m², preferably 1.3 to 3.2 g/m², very preferably 1.8 to 2.8 g/m².

Depending on the particular application of the release material of the invention it is possible to configure the anti-adhesive layers on either side of the paper carrier with equal or different release: in other words, to set different release properties on either side (controlled release).

Adhesives which can be used for the adhesive tapes include all pressure-sensitive adhesives, as mentioned, for example, in SATAS, Handbook of Pressure Sensitive Adhesive Technology, Third Edition. Particularly suitable adhesives are natural/synthetic rubber-based and acrylate-based adhesives, which can be applied from the melt or from solution.

Part of the invention, finally, is a single-sided or double-sided adhesive tape comprising a liner having the paper carrier of the invention.

The concept of the invention encompasses a paper carrier web whose particular densification and surface quality make it suitable for coating with highly viscous release lacquers, the paper basis consisting of a mixture of groundwood pulp and chemical pulp.

The paper composition employed in accordance with the invention, in conjunction with the manufacturing process, and together with the high degree of densification and high surface quality, offers advantages for certain release lacquer coatings, advantages of a kind which could not have been foreseen.

The paper carrier is composed not—as hitherto—of pure chemical pulp, but instead includes a preferably high fraction of groundwood pulp. On account of its manufacturing process, however, said carrier is particularly suitable for the coating of highly viscous release lacquers, both alone and in combination with polyolefinic or inorganic coatings (clay).

Within the paper industry the term “clay” is generally understood to refer to a further coating and/or to the application of a coating slip to a base paper for the purpose of enhancing the surface.

The paper carrier employed in accordance with the invention is outstandingly suitable, furthermore, for release lacquers, both alone and in combination with a further coating, and, moreover, preferably has an ideal-elastic range of >1.0 kN.

This makes it possible in particular for it to be used as an alternative to the known glassine silicone base papers.

Hereinbelow, with reference to a figure, is one preferred embodiment of the overall product construction, without any intention that this should have a restrictive effect in any form. The paper carrier 3, provided on both sides with an anti-adhesive coating, is wound up with a double-sided adhesive tape 2 to form a roll 1.

After the product has been unwound, the adhesive product 2 is located on the top face of the anti-adhesive paper carrier 3.

1. (canceled)

2. The lining material according to claim 10, wherein the paper carrier has
a density of 1.12 to 1.2 g/cm³ and/or
a basis weight of 40 to 140 g/m².

3. The lining material according to claim 10, wherein the paper carrier has an ideal-elastic range of 1.0 to 2.0 kN.

4. The lining material according to claim 10, wherein the fraction of groundwood pulp in the paper composition of the paper carrier is 20% to 80% by weight.

5. The lining material according to claim 10, which comprises a polyolefin on said top face and/or bottom face, wherein the polyolefin is selected from the group consisting of LDPE, HDPE or blends of the two aforementioned polyolefins.

6. The lining material according to claim 10, which comprises an inorganic coating on said top face and/or bottom face, wherein the inorganic coating is selected from the group consisting of chalk, kaolin, titanium dioxide and glue.

7. The lining material according to claim 10, wherein the antiadhesive layer applied to at least one of the coatings is selected from the group consisting of highly viscous silicone-free or low-silicone layers or silicone, paraffin, Teflon, waxes of and highly viscous solvent-free systems which function as release lacquers.

8. The lining material according to claim 10, wherein the paper carrier has been provided on the top face and on the bottom face with a coating, and an anti-adhesive layer has been applied to both coatings.

9. A single-sided or double-sided adhesive tape comprising a lining material according to claim 10.

10. A lining material comprising:
a) a paper carrier having a top face and a bottom face;
b) a coating of a polyolefin or an inorganic substance on the top face and/or the bottom face; and
c) an anti-adhesive layer applied to at least one of any coating on said top face and/or any coating on said bottom face;
wherein
i) the paper carrier comprises a paper composition comprising groundwood pulp;
ii) the groundwood pulp is present in the paper composition in a fraction of at least 5% by weight of the paper composition; and
iii) the paper carrier has a density of 0.9 to 1.3 g/cm³.
